(19) United States
(12) Patent Application Publication
(10) Pub. No.: US 2021/0292624 A1
(43) Pub. Date: Sep. 23, 2021

(54) ADHESIVE WITH PROTEIN

(71) Applicant: SOLENIS TECHNOLOGIES, L.P., Wilmington, DE (US)

(72) Inventor: Michael J. Birkeland, Wilmington, DE (US)

(73) Assignee: SOLENIS TECHNOLOGIES, L.P., Wilmington, DE (US)

(21) Appl. No.: 17/201,186

(22) Filed: Mar. 15, 2021

Related U.S. Application Data
(60) Provisional application No. 62/991,705, filed on Mar. 19, 2020.

(51) Int. Cl. C09J 189/00; B32B 7/12; B32B 21/02; B32B 21/14; B32B 21/13; B27N 3/00; B27N 3/04; B27N 3/02

(52) U.S. Cl. CPC C09J 189/00; B32B 7/12; B32B 21/02; B27N 3/02; B32B 21/13; B27N 3/002; B27N 3/04; B32B 21/14

(57) ABSTRACT

Adhesives, methods of producing adhesives, and cellulosic products formed with the adhesive are provided. In an exemplary embodiment, an adhesive includes a protein, a first reactant that has a plurality of isocyanate moieties, and a second reactant with one or more of a chlorohydrin moiety, an azetidinium moiety, and an epoxy moiety. The protein is reacted with the first reactant to form a functionalized protein intermediate, and the functionalized protein intermediate is then reacted with the second reactant.

This application claims the benefit of U.S. Provisional Application No. 62/991,705, filed Mar. 19, 2020.

### TECHNICAL FIELD

This application pertains to adhesives that include a protein as a component, methods of producing the same, and cellulosic products formed with the adhesives. More particularly, this application pertains to an adhesive produced with a protein pretreated with an isocyanate compound to form an intermediate, which is then reacted with an epichlorohydrin compound, and methods of producing and using the same.

### BACKGROUND

Adhesives that use a combination of protein and polyamideamine epichlorohydrin (PAE) resins are known. In some embodiments, these adhesives are used with cellulosic or ligno-cellulosic materials to form plywood, oriented strand board (OSB), medium density fiberboard (MDF), and other cellulosic or ligno-cellulosic composite materials. References herein to cellulosic materials are intended to include ligno-cellulosic materials as well. These composite materials are widely used in construction, home repair, and many other industries.

Adhesives formed from soy and PAE resins have some limitations. For example, these adhesives tend to have high viscosity when formulated at a desirable solids content, they tend to have a short pot life, the adhesive may delaminate when exposed to water for extended periods, and the PAE resin is expensive.

Accordingly, it is desirable to provide adhesives, methods of producing adhesives, and composite cellulosic products with a soy based adhesive having superior strength when exposed to water. In addition, there is a need for a soy based adhesives, methods of producing the same, and composite cellulosic products having superior strength and reduced PAE concentrations. Other desirable features and characteristics of the present embodiment will become apparent from the subsequent detailed description and the appended claims, taken in conjunction with the accompanying drawings and this background.

### BRIEF SUMMARY

Adhesives, methods of producing adhesives, and cellulosic products formed with the adhesives are provided. In an exemplary embodiment, an adhesive includes a protein, a first reactant that has a plurality of isocyanate moieties, and a second reactant with one or more of a chlorohydrin moiety, an azetidinium moiety, and an epoxy moiety. The protein is reacted with the first reactant to form a functionalized protein intermediate, and the functionalized protein intermediate is then reacted with the second reactant.

A cellulosic product is provided in another embodiment. The cellulosic product includes a first cellulosic substrate adhered to a second cellulosic substrate with an adhesive. The adhesive includes a protein, a first reactant, and a second reactant, where the first reactant includes a plurality of isocyanate moieties, and the second reactant includes one or more of a chlorohydrin moiety, an azetidinium moiety, and an epoxy moiety. The first reactant is reacted with the protein to form a functionalized protein intermediate, and the functionalized protein intermediate is then reacted with the second reactant.

A method of producing an adhesive is provided in yet another embodiment. The method includes combining a protein with a first reactant to produce a functionalized protein intermediate, where the first reactant has a plurality of isocyanate moieties. The functionalized protein intermediate is combined with a second reactant to produce the adhesive, where the second reactant includes one or more of a chlorohydrin moiety, an azetidinium moiety, and an epoxy moiety.

### BRIEF DESCRIPTION OF THE DRAWINGS

Embodiments of the subject matter will hereinafter be described in conjunction with the following figures, wherein like numerals denote like elements, and wherein:

FIG. 1 is a schematic illustration of an embodiment of a method of producing an adhesive, and the adhesive produced; and

FIGS. 2 and 3 are side sectional views of different embodiments of a cellulosic product.

### DETAILED DESCRIPTION

The features and advantages of the present description will be more readily understood, by those of ordinary skill in the art, from reading the following detailed description. It is to be appreciated that certain features of this description, which are, for clarity, described above and below in the context of separate embodiments, may also be provided in combination in a single embodiment. Conversely, various features of this description that are, for brevity, described in the context of a single embodiment, may also be provided separately or in any sub-combination. In addition, references in the singular may also include the plural (for example, “a” and “an” may refer to one, or one or more than one, unless the context specifically states otherwise.

A protein is combined with a first reactant to produce a functionalized protein intermediate, where the first reactant includes a plurality of isocyanate moieties. An exemplary first reactant includes hexamethylene diisocyanate, but other di-isocyanates, tri-isocyanates, and multi-isocyanates may also be utilized as the first reactant, such as polymeric diphenylmethane diisocyanate (pMDI), toluene diisocyanate (TDI) or other compounds. The functionalized protein intermediate is reacted with a second reactant that includes one or more of a chlorohydrin moiety, an azetidinium moiety, and an epoxy moiety to produce the adhesive. An exemplary second reactant is polyamideamine epichlorohydrin (PAE) resins, but other reactants with one or more of a chlorohydrin moiety, an azetidinium moiety, and an epoxy moiety may be utilized in alternate embodiments. The adhesive provides superior wet strength than comparable adhesives using protein and PAE, but without the pre-treatment with the second reactant.

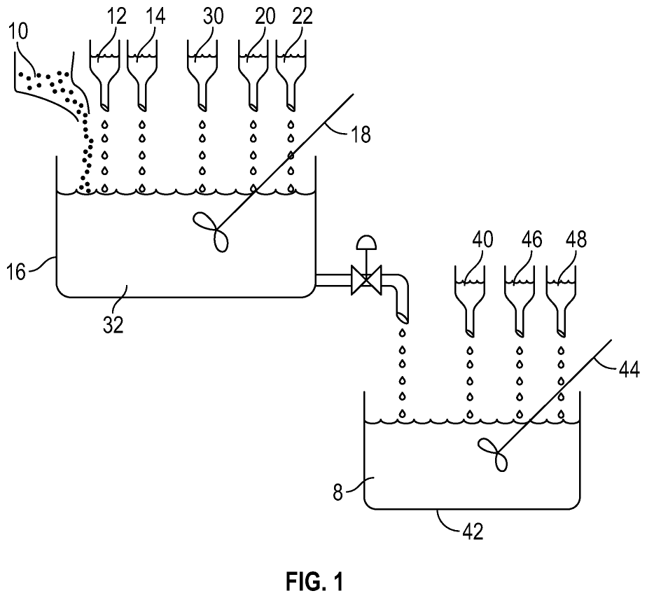

Referring to the schematic illustration in FIG. 1, a protein 10 is combined with water 12 in a preliminary step in the production of the adhesive 8. The protein 10 is a soy protein in an exemplary embodiment, but it may be possible to utilize alternate sources of protein in alternate embodiments. Exemplary alternate protein sources include, but are not limited to, blood meal, feather meal, keratin, gelatin, collagen, gluten, casein, etc. The protein 10 may be derived from a plant in exemplary embodiments. For example, a soy protein may be derived from soy flour, soy concentrate, soy isolate, or other soy products. The protein 10 may be pretreated or modified to improve its solubility, dispersibility and/or reactivity. One particularly useful source of protein 10 is soy flour, which may be about 50 wt. % protein, on a dry basis, but alternate sources of protein 10 include protein concentrate (about 65 wt. % protein, dry basis) and protein isolate (SPI, at least about 85 wt. % protein, dry basis). The term “about,” as used herein, means+ or −10% from the stated value, unless otherwise specified. In an exemplary embodiment, the protein 10 is added in an amount of about 10 to about 50 weight percent, based on a total weight of the adhesive 8, but in alternate embodiments the protein 10 may be added in an amount of about 20 to about 40 weight percent, or about 25 to about 40 weight percent, based on a total weight of the adhesive 8. The amount of solvent, such as water 12, may vary substantially, so the total amount of protein 10 may be expressed based on a total weight of the solids, where the weight of the solids is the weight of non-volatile solids that remain after all liquids are removed. The protein 10 may be present in the final adhesive 8 in an amount of from about 40 to about 95 percent by weight of the solids, or from about 50 to about 90 percent by weight of the solids, or from about 55 to about 90 percent by weight of the solids, all based on a total weight of the solids within the adhesive 8.

The water 12 is deionized in an exemplary embodiment, but distilled water, spring water, or other types of water may be utilized in alternate embodiments. The water 12 may be present in the final adhesive 8 in an amount of from about 25 to about 70 weight percent, or from about 30 to about 60 weight percent, or from about 35 to 55 weight percent, all based on the total weight of the adhesive 8.

A defoamer 14 may optionally be added to the water 12 in an exemplary embodiment to control foaming. The defoamer 14 is a non-ionic surfactant in an exemplary embodiment, but cationic, anionic, and/or amphoteric surfactants may be utilized in alternate embodiments. The defoamer 14 aids in control of foaming, and is preferably a non-toxic material. In an exemplary embodiment, the defoamer 14 is an alkoxylated alcohol, but many other types of defoamers 14 may be utilized in alternate embodiments. In an exemplary embodiment, the defoamer 14 may be present in the final adhesive 8 in an amount of from about 0.01 to about 5 weight percent, based on a total weight of the adhesive 8.

The protein 10, the optional defoamer 14, and the water 12 may be mixed to disperse the protein 10 in the water 12. In an exemplary embodiment, about half of the total protein 10 is combined with the water 12 and defoamer 14 and agitated until the protein 10 is dispersed, and then the remaining half of the protein 10 is added and agitated until all the protein 10 is dispersed in the water 12. In an exemplary embodiment, the protein 10, water 12, and optional defoamer 14 may be combined in a first vessel 16, where a first agitator 18 is utilized for mixing. The first vessel 16 may be a tank, reactor, pipe, or essentially any container capable of containing the components. The first agitator 18 may be an impeller, a turbine, an in-line mixer, or essentially any type of device capable of mixing and/or blending the components. The design and features of the first vessel 16 and first agitator 18 may vary widely in various embodiments.

Once the protein 10 and water 12 are blended, the pH may be adjusted to a first pH set point. In an exemplary embodiment, the first pH set point is from about 5 to about 10, but in alternate embodiments the first pH set point is about 6, or about 7, or about 8, or about 9, where the first pH set point may be within about 0.5 pH units from the first pH set point. In other embodiments, the first pH set point may be from 5 to 13, or from 7 to 12. Other possible first pH set points are also possible. The first pH set point may be adjusted with a first base 20, or with a first acid 22, as needed. The first base 20 may be sodium hydroxide, but a wide variety of alternate bases or combinations of bases may also be utilized in alternate embodiments. Possible alternate or additional bases 20 include, but are not limited to, ammonia, calcium hydroxide, lithium hydroxide, potassium hydroxide, methylamine, pyridine, zinc hydroxide, etc. The first base 20 is capable of raising the pH of the protein 10 and water 12 dispersion. The first acid 22 may be hydrochloric acid, but a wide variety of alternate acids or combinations of acids may be used, as long as the first acid 22 can lower the pH of the protein 10 and water 12 dispersion. Possible acids include, but are not limited to, sulfuric acid, hydrofluoric acid, acetic acid, nitric acid, phosphoric acid, and many others.

A first reactant 30 is added to the protein 10 and water 12 dispersion to produce a functionalized protein intermediate 32. The first reactant 30 includes a plurality of isocyanate moieties. Not to be bound by theory, but it is hypothesized that the isocyanate moieties react with amine functional groups that are present on the protein 10. The protein 10 may include glycinin and β-conglycinin proteins, which include amine functional groups. Exemplary first reactants 30 may include, but are not limited to, hexamethylene diisocyanate, poly-methylene diphenyl diisocyanate, methylene bis(phenyl isocyanate), toluene diisocyanate, naphthalene diisocyanate, isophorone diisocyanate, and combinations thereof. The first reactant 30, the protein 10, and the water 12 dispersion may be mixed for about 30 minutes or more at about room temperature, such as about 20 degrees Celsius (° C.) to about 50° C., before proceeding. The mixing time allows the first reactant 30 to react with the protein 10, but shorter mixing periods are also possible, as are alternate reaction temperatures. In an exemplary embodiment, the first reactant 30 is present in the final adhesive 8 in an amount of from about 0.1 to about 5 weight percent, based on the total weight of the adhesive 8. In alternate embodiments, the first reactant 30 is present in an amount of from about 0.2 to about 3 weight percent, or from about 0.3 to about 2 weight percent, based on the total weight of the adhesive 8. The first reactant 30 and the protein 10 may be present in a protein to first reactant ratio (weight/weight ratio) of from about 0.5/100 to about 20/100, or from about 1/100 to about 15/100, or from about 1.5/100 to about 5/100 in various embodiments.

The functionalized protein intermediate 32, once formed, may be combined with a second reactant 40, where the second reactant 40 includes one or more of a chlorohydrin moiety, an azetidinium moiety, and an epoxy moiety. The second reactant 40 may be derived from a compound with an epichlorohydrin moiety in some embodiments. In an exemplary embodiment, the second reactant 40 is PAE resin (polyamideamine epichlorohydrin, as mentioned above), but alternate second reactants 40 that include one or more of a chlorohydrin moiety, an azetidinium moiety, and an epoxy moiety may be utilized in alternate embodiments. The second reactant 40 may be present in the adhesive 8 in an amount of from about 1 to about 30 weight percent in an exemplary embodiment, but in alternate embodiments the second reactant 40 may be present in an amount of from about 2 to about 30 weight percent, or from about 4 to about 20 weight percent, all based on the total weight of the adhesive 8. As described above, the amount of solvent may vary, so the second reactant may be present in an amount of from about 5 to about 60 percent by weight of the solids, or from about 8 to about 50 percent by weight of the solids, or from about 10 to about 40 percent by weight of the solids, based on the total weight of the solids of the adhesive 8.

The second reactant 40 may be combined with the functionalized protein intermediate 32 in a second vessel 42, and mixed with a second agitator 44, where the second vessel and agitator 42, 44 may have a wide variety of embodiments, similar to the first vessel and agitator 16, 18 as described above. In an alternate embodiment, the second reactant 40 may be combined with the functionalized protein intermediate 32 in the first vessel 16, where the specific vessels/and agitators are not critical to the production of the adhesive 8.

After the second reactant 40 and functionalized protein intermediate 32 have been mixed and allowed to react, the pH is adjusted to about 7.0, or from about 6.0 to about 8.0, to produce the adhesive 8. The pH may be adjusted with a second base 46 and/or a second acid 48, where the second base and/or acid 46, 48 are capable of adjusting the pH up or down, respectively. The second base 46 and second acid 48 may be a wide variety of different bases and acids, as described above for the first base 20 and first acid 22. The total quantity of the first and second base 20, 46 may be present in the adhesive 8 in an amount of from about 0.1 to about 2 weight percent, based on the total weight of the adhesive 8, or from about 0.1 to about 5 percent by weight of the solids, based on the total weight of the solids of the adhesive 8. The total quantity of the first and second acid 22, 28 that may be present in the adhesive 8 is from about 0 to about 5 weight percent, based on the total weight of the adhesive 8, or from about 0 to about 1 percent by weight of the solids, based on the total weight of the solids of the adhesive 8.

The first reactant 30 is reacted with the protein 10 to form the functionalized protein intermediate 32 prior to adding the second reactant 40 for another reaction, as described above. Not to be bound by theory, but it is theorized that the structure of the resulting material is different than if the same compounds are used, but the second reactant 40 were to be reacted with the protein 10 prior to reacting the first reactant 30. The functionalized protein intermediate 32 results in the first reactant 30 being directly bound to the protein 10, and the second reactant 40 may be bound to first reactant 30 such that the first reactant 30 is bound between the second reactant 40 and the protein 10. This produces a different structure than if the second reactant 40 were to be combined with the protein 10 before the first reactant 30, because then the second reactant 40 would then be directly bound to the protein 10. As such, the description of the adhesive 8 as being produced with the functionalized protein intermediate 32 describes an adhesive 8 that has a different structure than one formed without the functionalized intermediate 32.

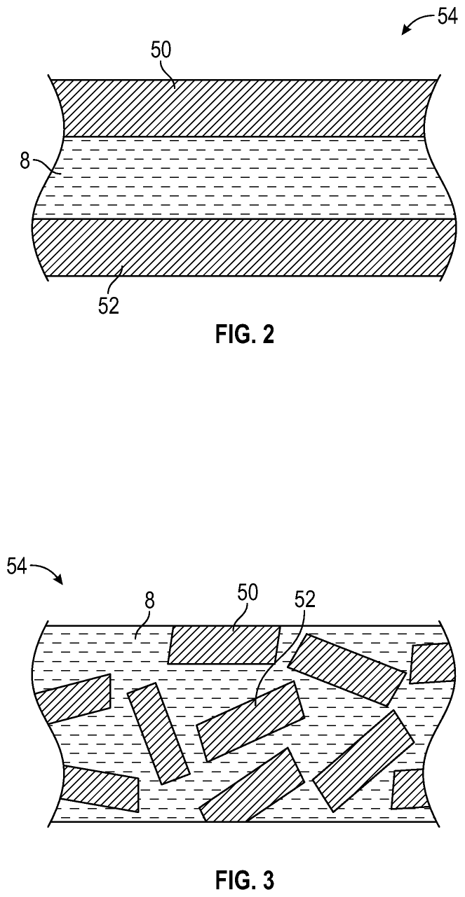

A first cellulosic substrate 50 is adhered to a second cellulosic substrate 52 with the adhesive 8 in an exemplary embodiment, as illustrated in FIGS. 2 and 3 with continuing reference to FIG. 1. The first cellulosic substrate 50 may be the same material as the second cellulosic substrate 52, or the first cellulosic substrate 50 may be a different material than the second cellulosic substrate 52. The first and second cellulosic substrates 50, 52 and the adhesive 8 form at least a part of a cellulosic product 54, such as plywood, OSB, MDF, or other cellulosic products 54. The first and second cellulosic substrates 50, 52, may be particles, such as in OSB, particleboard, or MDF, as illustrated in FIG. 3, or the first and second cellulosic substrates 50, 52, may be sheets or blocks, such as in plywood or laminated beams, as illustrated in FIG. 2.

### EXPERIMENTAL

The adhesive 8 was tested for wet strength, and the results indicate an unexpected benefit when the first reactant 30 was combined with the protein 10 before the addition of the second reactant 40, as compared to standard examples where the protein 10 was combined with the second reactant 40 prior to being combined with the first reactant 30. Table 1 below lists ABES wet test strength of comparative adhesives 8 where the functionalized protein intermediate 32 was prepared at a pH of about 7. The “STANDARD” samples combined the second reactant 40 with the protein 10 prior to adding the first reactant 30, and the “TEST” samples combined the first reactant 30 with the protein 10 to form the functionalized protein intermediate 32 prior to adding the second reactant 40, as described herein. All quantities in TABLE 1 are provided in grams.

TABLE 1

| | STAND- | | STAND- | | STAND- | |
|---|---|---|---|---|---|---|
| | ARD | TEST | ARD | TEST | ARD | TEST |
| | 1 | 1 | 2 | 2 | 3 | 3 |
| PSI to | 139.5 | 162.8 | 291.0 | 369.5 | 315.8 | 425.3 |
| delam- | | | | | | |
| inate¹ | | | | | | |
| PAE² | 8.02 | 8.05 | 18.79 | 18.80 | 28.13 | 28.23 |
| HDI³ | 1.44 | 1.45 | 1.35 | 1.35 | 1.27 | 1.27 |
| pH of | N/A | 6.96 | N/A | 6.91 | N/A | 6.96 |
| HDI⁴ | | | | | | |
| Protein⁵ | 50.66 | 50.83 | 47.46 | 47.49 | 44.42 | 44.57 |
| Water | 113.35 | 113.85 | 106.24 | 106.34 | 99.31 | 99.76 |
| De- | 0.19 | 0.19 | 0.18 | 0.18 | 0.17 | 0.17 |
| foamer⁶ | | | | | | |
| NaOH⁷ | 0.64 | 0.64 | 0.98 | 0.84 | 1.7 | 1.0 |
| HCl⁸ | 0.70 | 0 | 0 | 0 | 0 | 0 |
| pH of | 7.69 | 6.38 | 6.84 | 5.83 | 6.17 | 5.60 |
| PAE⁹ | | | | | | |
| pH final | 6.80 | 6.97 | 6.96 | 6.96 | 6.98 | 7.14 |
| Vis- | 6,880 | 100,000 | 13,800 | 88,400 | 10,500 | 103,200 |
| cosity | | | | | | |
| @ 10 | | | | | | |
| rpm¹⁰ | | | | | | |
| Vis- | 5,460 | 63,800 | 10,200 | 54,400 | 8,440 | 68,000 |
| cosity | | | | | | |
| @ 20 | | | | | | |
| rpm¹⁰ | | | | | | |

¹Samples were prepared using hard maple veneer coupons that were 118 millimeters (mm) by 20 mm by 1 mm. The dimensions of the glued space were 20 mm by 5 mm. The cure pressure was 2.2 bar, at a temperature of 120° C. for 120 seconds, followed by a cure time of at least 24 hours at 21° C. and 50% relative humidity. The wet strength test included a 4 hour soak under deionized water at 23° C., after which the samples were removed from the water bath, blotted dry to remove excess water, and tested wet. The samples were pulled apart using an MTS tester, with a data acquisition rate of 10.0 Hz and an initial speed of 5.58 mm/minute.
²PAE resin was CA1130 PAE resin from Solenis ®.
³HDI is hexamethylene diisocyanate, HW2000, provided by BASF ®
⁴pH of HDI indicates the pH at the beginning of the addition of the first reactant
(hexamethylene diisocyanate in this example).
⁵The protein was Prolia 200/90 soy flour, from Cargill ®. The 200 refers to the grind of the flour, and the 90 refers to the protein dispersibility index (PDI).
⁶The defoamer was Advantage 1529 defoamer, from Solenis ®. This is an alkoxylated alcohol non-ionic defoamer.
⁷NaOH was 25% NaOH in water, by weight.
⁸HCl was 25% HCl in water, by weight.
⁹The pH of PAE indicates the pH prior to the addition of PAE resin.
¹⁰Viscosity is reported in centipoise, and was measured by a rotational viscometer at a temperature of 25° C., using an LV06 or LV07 cylindrical spindle at the indicated speed, in revolutions per minute, with a Brookfield ® DV2T viscometer.

TABLE 2 provides the same data at TABLE 1, with the exception that the functionalized protein intermediate 32 was prepared at a pH of about 9. In TABLE 2, the “STANDARD” samples combined the second reactant 40 with the protein 10 prior to adding the first reactant 30, and the “TEST” samples combined the first reactant 30 with the protein 10 to form the functionalized protein intermediate 32 prior to adding the second reactant 40, as in TABLE 1. All quantities in TABLE 2 are provided in grams.

TABLE 2

| | STAND- | | STAND- | | STAND- | |
|---|---|---|---|---|---|---|
| | ARD | | ARD | | ARD | |
| | 4 | TEST 4 | 5 | TEST 5 | 6 | TEST 6 |
| PSI to | 135.9 | 191.2 | 291.0 | 380.0 | 315.8 | 465.8 |
| delam- | | | | | | |
| inate¹ | | | | | | |
| PAE² | 8.02 | 8.01 | 18.79 | 18.73 | 28.13 | 28.08 |
| HDI³ | 1.44 | 1.44 | 1.35 | 1.35 | 1.27 | 1.26 |
| pH of | N/A | 9.16 | N/A | 9.22 | N/A | 9.28 |
| HDI⁴ | | | | | | |
| Protein⁵ | 50.66 | 50.58 | 47.46 | 47.32 | 44.42 | 44.34 |
| Water | 113.35 | 113.11 | 106.24 | 105.82 | 99.31 | 99.07 |
| De- | 0.19 | 0.19 | 0.18 | 0.18 | 0.17 | 0.17 |
| foamer⁶ | | | | | | |
| NaOH⁷ | 0.64 | 1.33 | 0.98 | 1.6 | 1.7 | 2.07 |
| HCl⁸ | 0.7 | 0.3 | 0 | 0 | 0 | 0 |
| pH of | 7.69 | 7.31 | 6.84 | 6.39 | 6.17 | 6.04 |
| PAE⁹ | | | | | | |
| pH final | 6.80 | 6.92 | 6.96 | 6.93 | 6.98 | 6.88 |
| Vis- | 6,880 | 72,300 | 13,800 | 95,600 | 10,500 | 110,800 |
| cosity | | | | | | |
| @ 10 | | | | | | |
| rpm¹⁰ | | | | | | |
| Vis- | 5,460 | 46,500 | 10,200 | 66,400 | 8,440 | 73,600 |
| cosity | | | | | | |
| @ 20 | | | | | | |
| rpm¹⁰ | | | | | | |

¹Samples were prepared using hard maple veneer coupons that were 118 millimeters (mm) by 20 mm by 1 mm. The dimensions of the glued space were 20 mm by 5 mm. The cure pressure was 2.2 bar, at a temperature of 120° C. for 120 seconds, followed by a cure time of at least 24 hours at 21° C. and 50% relative humidity. The wet strength test included a 4 hour soak under deionized water at 23° C., after which the samples were removed from the water bath, blotted dry to remove excess water, and tested wet. The samples were pulled apart using an MTS tester, with a data acquisition rate of 10.0 Hz and an initial speed of 5.58 mm/minute.
²PAE resin was CA1130 PAE resin from Solenis ®.
³HDI is hexamethylene diisocyanate, HW2000, provided by BASF ®
⁴pH of HDI indicates the pH at the beginning of the addition of the first reactant (hexamethylene diisocyanate in this example).
⁵protein was Prolia 200/90 soy flour, from Cargill ®. The 200 refers to the grind of the flour, and the 90 refers to the protein dispersibility index (PDI).
⁶The defoamer was Advantage 1529 defoamer, from Solenis ®. This is an alkoxylated alcohol non-ionic defoamer.
⁷NaOH was 25% NaOH in water, by weight.
⁸HCl was 25% HCl in water, by weight.
⁹pH of PAE indicates the pH prior to the addition of PAE resin.
¹⁰Viscosity is reported in centipoise, and was measured by a rotational viscometer at a temperature of 25° C., using an LV06 or LV07 cylindrical spindle at the indicated speed, in revolutions per minute, with a Brookfield ® DV2T viscometer.

The test data clearly shows the preparation of the functionalized protein intermediate 32 produces an unexpected benefit, because the addition of the same first reactant 30 (hexamethylene diisocyanate) after reacting the protein 10 with PAE resin 40 results in a significantly lower wet test strength as well as significantly decreased viscosity than when the first reactant 30 (hexamethylene diisocyanate) is added to the protein 10 prior to reaction with the PAE resin.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An adhesive product comprising:
a protein;
a first reactant comprising a plurality of isocyanate moieties;
a second reactant comprising one or more of a chlorohydrin moiety, an azetidinium moiety, and an epoxy moiety; and
wherein the protein is reacted with the first reactant to form a functionalized protein intermediate, and wherein the functionalized protein intermediate is reacted with the second reactant.

2. The adhesive product of claim 1, further comprising:
water, wherein the water is present in the adhesive product at from about 30 to about 70 weight percent, based on a total weight of the adhesive product.

3. The adhesive product of claim 1, wherein:
the protein is present in the adhesive product at from about 50 to about 90 percent by weight of solids, the first reactant is present in the adhesive product at from about 1 to about 10 percent by weight of the solids, and the second reactant is present in the adhesive product at from about 10 to about 40 percent by weight of the solids, all based on a total weight of the solids of the adhesive product.

4. The adhesive product of claim 1, wherein:
the second reactant is polyamideamine epichlorohydrin.

5. The adhesive product of claim 4, wherein:
the first reactant is selected from the group of hexamethylene diisocyanate, poly methylene diphenyl diisocyanate, methylene bis(phenyl isocyanate), toluene isocyanate, naphthalene diisocyanate, isophorone diisocyanate, and combinations thereof.

6. The adhesive product of claim 4, wherein the first reactant is hexamethylene diisocyanate.

7. The adhesive product of claim 1, wherein the functionalized protein intermediate is formed at a pH of 7 or greater.

8. The adhesive product of claim 1, wherein:
the protein is a soy protein derived from soy flour, soy concentrate, or soy isolate.

9. A cellulosic product comprising:
a first cellulosic substrate;
a second cellulosic substrate;
an adhesive adhering the first cellulosic substrate to the second cellulosic substrate, wherein the adhesive comprises a protein, a first reactant, and a second reactant, wherein the first reactant comprises a plurality of isocyanate moieties, the second reactant comprises one or more of a chlorohydrin moiety, an azetidinium moiety, and an epoxy moiety, and wherein the protein was reacted with the first reactant to produce a functionalized protein intermediate prior to reacting with the functionalized protein intermediate with the second reactant.

10. The cellulosic product of claim 9, wherein:
the first reactant is selected from the group of hexamethylene diisocyanate, poly methylene diphenyl diisocyanate, methylene bis(phenyl isocyanate), toluene isocyanate, naphthalene diisocyanate, isophorone diisocyanate, and combinations thereof, and the second reactant is polyamideamine epichlorohydrin.

11. A method of producing an adhesive, the method comprising the steps of:
combining a protein with a first reactant to produce a functionalized protein intermediate, wherein the first reactant comprises a plurality of isocyanate moieties;
combining the functionalized protein intermediate with a second reactant to produce the adhesive, wherein the second reactant comprises one or more of a chlorohydrin moiety, an azetidinium moiety, and an epoxy moiety.

12. The method of claim 11, wherein:
combining the protein with the first reactant comprises combining the protein with the first reactant in an aqueous medium at a pH of about 7 or greater.

13. The method of claim 11, wherein:
combining the protein with the first reactant comprises combining the protein with the first reactant in an aqueous medium at a pH of about 9 or greater.

14. The method of claim 11, wherein:
combining the protein with the first reactant comprises combining the protein with the first reactant at a protein to first reactant weight ratio of from about 1/100 to about 15/100.

15. The method of claim 11, wherein:
combining the functionalized protein intermediate with the second reactant comprises combining the functionalized protein intermediate with the second reactant wherein the second reactant is polyamideamine epichlorohydrin.

16. The method of claim 15, wherein:
combining the protein with the first reactant comprises combining the protein with the first reactant wherein the first reactant is selected from the group of hexamethylene diisocyanate, poly methylene diphenyl diisocyanate, methylene bis(phenyl isocyanate), toluene isocyanate, naphthalene diisocyanate, isophorone diisocyanate, and combinations thereof.

17. The method of claim 15, wherein:
combining the protein with the first reactant comprises combining the protein with the first reactant wherein the first reactant is hexamethylene diisocyanate.

18. The method of claim 11, further comprising:
dispersing the protein in water prior to combining the protein with the first reactant; and
adjusting a pH of the protein dispersed in the water to about 7 or greater prior to combining the protein with the first reactant.

19. The method of claim 18, further comprising:
adding a defoamer to the protein intermediate prior to combining the protein with the first reactant.

20. The method of claim 11 further comprising:
adhering a first cellulosic substrate to a second cellulosic substrate with the adhesive
